(19) United States
(12) Patent Application Publication
(10) Pub. No.: US 2026/0166486 A1
(43) Pub. Date: Jun. 18, 2026

(54) SYSTEM AND METHOD FOR BYPASSING CARBON CAPTURE SYSTEM OF GAS TURBINE ENGINE

(71) Applicant: GENERAL ELECTRIC TECHNOLOGY GMBH, Baden (CH)

(72) Inventors: Bradly Aaron KIPPEL, Greenville, SC (US); Christopher Conrad FRESE, Greenville, SC (US); Sankara Subramanian KALANITHI, Bangalore (IN); Hongtao LI, Baden (CH)

(21) Appl. No.: 19/125,367

(22) PCT Filed: Nov. 4, 2022
(86) PCT No.: PCT/US2022/049015

§ 371 Date: Apr. 29, 2025

(51) Int. Cl. B01D 53/86; B01D 53/02; B01D 53/14; B01D 53/18; F01N 3/20

(52) U.S. Cl. CPC B01D 53/8631; B01D 53/02; B01D 53/1425; B01D 53/18; F01N 3/2066

(57) ABSTRACT

A system is provided with a bypass system having a first valve, a first drive coupled to the first valve, and a controller coupled to the first drive. The controller is configured to operate the first drive to move the first valve between a first position and a second position. The first position of the first valve opens a gas treatment flow path and closes a bypass flow path for an exhaust gas flow from a gas turbine engine. The second position of the first valve closes the gas treatment flow path and opens the bypass flow path for the exhaust gas flow from the gas turbine engine. The gas treatment flow path is configured to extend through a gas treatment system having a gas capture system. The bypass flow path is configured to bypass the gas treatment system having the gas capture system.

### BACKGROUND

The present application relates generally to a system and method for treating a gas, such as an exhaust gas.

An industrial plant, such as a power plant, may produce a variety of gases, such as an exhaust gas of a combustion system. The combustion system may include a gas turbine engine, a reciprocating piston-cylinder engine, a furnace, a boiler, or other industrial equipment. These exhaust gases may include one or more undesirable gases, such as acid gases and/or greenhouse gases. For example, the undesirable gases may include carbon oxides (COₓ) such as carbon dioxide (CO₂) and carbon monoxide (CO), nitrogen oxides (NOₓ) such as nitrogen dioxide (NO₂), and/or sulfur oxides (SOₓ) such as sulfur dioxide (SO₂). CO₂ is both an acid gas and a greenhouse gas. Unfortunately, various conditions of the industrial plant can complicate the use of a gas treatment system, including startup conditions, low load conditions, malfunctioning gas treatment parts, or a combination thereof. Accordingly, a need exists for a gas treatment system having a bypass system configured to bypass the gas treatment system in certain conditions.

### BRIEF DESCRIPTION

Certain embodiments commensurate in scope with the originally claimed subject matter are summarized below. These embodiments are not intended to limit the scope of the claimed embodiments, but rather these embodiments are intended only to provide a brief summary of possible forms of the subject matter. Indeed, the presently claimed embodiments may encompass a variety of forms that may be similar to or different from the embodiments set forth below.

In certain embodiments, a system includes a bypass system having a first valve, a first drive coupled to the first valve, and a controller coupled to the first drive. The controller is configured to operate the first drive to move the first valve between a first position and a second position. The first position of the first valve opens a gas treatment flow path and closes a bypass flow path for an exhaust gas flow from a gas turbine engine. The second position of the first valve closes the gas treatment flow path and opens the bypass flow path for the exhaust gas flow from the gas turbine engine. The gas treatment flow path is configured to extend through a gas treatment system having a gas capture system. The bypass flow path is configured to bypass the gas treatment system having the gas capture system.

In certain embodiments, a system includes a controller coupled to a bypass system having a first drive coupled to a first valve, wherein the controller is configured to operate the first drive to move the first valve between a first position and a second position. The first position of the first valve opens a gas treatment flow path and closes a bypass flow path for an exhaust gas flow from a gas turbine engine. The second position of the first valve closes the gas treatment flow path and opens the bypass flow path for the exhaust gas flow from the gas turbine engine. The gas treatment flow path is configured to extend through a gas treatment system having a gas capture system. The bypass flow path is configured to bypass the gas treatment system having the gas capture system.

In certain embodiments, a method includes controlling a first drive to move a first valve of a bypass system to a first position to open a gas treatment flow path and close a bypass flow path for an exhaust gas flow from a gas turbine engine, wherein the gas treatment flow path is configured to extend through a gas treatment system having a gas capture system. The method also includes controlling the first drive to move the first valve of the bypass system to a second position to close the gas treatment flow path and open the bypass flow path for the exhaust gas flow from the gas turbine engine, wherein the bypass flow path is configured to bypass the gas treatment system having the gas capture system.

### BRIEF DESCRIPTION OF THE DRAWINGS

These and other features, aspects, and advantages of the presently disclosed techniques will become better understood when the following detailed description is read with reference to the accompanying drawings in which like characters represent like parts throughout the drawings, wherein:

FIG. 1 is a block diagram of an embodiment of a combined cycle power plant having a bypass system for a gas treatment system having a gas capture system, wherein the combined cycle power plant includes a gas turbine engine, a heat recovery steam generator (HRSG), and a steam turbine.

FIG. 2 is a block diagram of an embodiment of the combined cycle power plant of FIG. 1, further illustrating details of the gas capture system and the bypass system.

FIG. 3 is a schematic of an embodiment of the combined cycle power plant of FIG. 1, further illustrating a lower level bypass configuration of the bypass system coupled to an exhaust stack.

FIG. 4 is a schematic of an embodiment of the combined cycle power plant of FIGS. 1-3, further illustrating an elevated level bypass configuration of the bypass system coupled to the exhaust stack.

FIG. 5 is a schematic of an embodiment of the combined cycle power plant of FIGS. 1-4, further illustrating details of the bypass system coupled to the exhaust stack and the gas treatment system.

FIG. 6 is a schematic of an embodiment of a seal gas system of the combined cycle power plant of FIGS. 1-5, illustrating details of seal components, a seal gas injector, and a seal system coupled to the bypass system.

### DETAILED DESCRIPTION

One or more specific embodiments of the presently disclosed systems are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the presently disclosed embodiments, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include systems and methods for bypassing a gas treatment system, such as a carbon capture system, using a bypass system. The bypass system is configured to divert an exhaust gas flow through an exhaust stack when a bypass is needed for the gas treatment system. For example, the bypass system may include a damper system configured to move between a first position that routes the exhaust flow through the gas treatment system and a second position that routes the exhaust flow through the exhaust stack. A control system may be coupled to the bypass system and a monitoring system to determine when to move the bypass system between the first and second positions. A seal system also may route a seal fluid flow (e.g., a seal gas flow) to one or more seals of the bypass system to avoid leakage of the exhaust gas, undesirable gases (e.g., x) being captured in the gas treatment system, or a combination thereof. For example, the seal fluid flow may include an air flow and/or an inert gas flow, such as a nitrogen flow. The seal system is configured to pressurize the seal fluid flow, thereby providing a seal pressure that is greater than an adjacent flow to help block leakage. Various aspects and embodiments of the gas treatment system are discussed in further detail below.

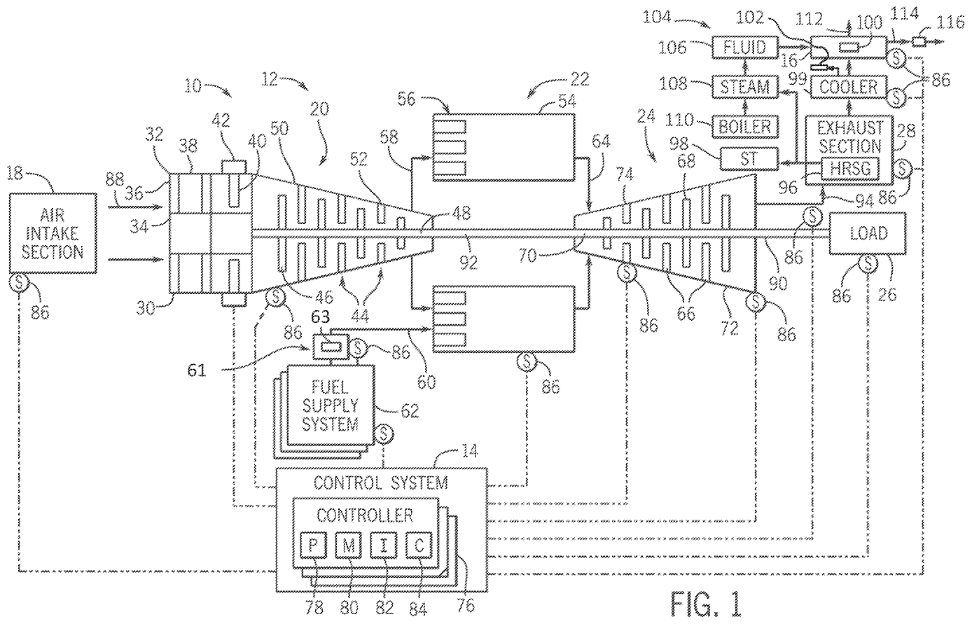

FIG. 1 is a block diagram of an embodiment of a combined cycle power plant 10 having a gas turbine engine 12 coupled to a control system 14. As discussed in further detail below, the combined cycle power plant 10 may include a gas treatment system 16 to treat one or more gases in the gas turbine engine 12. In the disclosed embodiments, the gas treatment system 16 includes a gas capture system 100 having a bypass system 102, wherein the bypass system 102 is configured to bypass the gas treatment system 16 in certain conditions (e.g., startup conditions, low load conditions, malfunctioning gas treatment components such as a fan trip, etc.). The various features of the gas treatment system 16 are discussed in further detail below, and the various features may be used in any suitable combination with one another. However, before moving on to the gas treatment system 16, the combined cycle power plant 10 will be described as one possible context for use of the gas treatment system 16.

The gas turbine engine 12 includes an air intake section 18, a compressor section 20, a combustor section 22, a turbine section 24, a load 26, and an exhaust section 28. The air intake section 18 may include a duct having one or more silencer baffles, fluid injection systems (e.g., heated fluid injection for anti-icing), air filters, or any combination thereof. The compressor section 20 may include an upstream inlet duct 30 having a bell mouth 32, wherein the inlet duct 30 includes an air intake path between an inner hub 34 and an outer wall 36. The inlet duct 30 also includes stationary vanes 38 and inlet guide vanes (IGVs) 40. The inlet guide vanes 40 also may be coupled to one or more actuators 42, which are communicatively coupled to and controlled by the control system 14.

The compressor section 20 includes one or more compressor stages 44, wherein each compressor stage 44 includes a plurality of compressor blades 46 coupled to a compressor shaft 48 within a compressor casing 50, and a plurality of compressor vanes 52 coupled to the compressor casing 50. The compressor blades 46 and the compressor vanes 52 are arranged circumferentially about a central axis of the compressor shaft 48 within each compressor stage 44. The compressor stages 44 may include between 1 and 30 or more compressor stages. Additionally, the compressor stages 44 alternative between sets of the compressor blades 46 and sets of the compressor vanes 52 in the direction of air flow through the compressor section 20. In operation, the compressor stages 44 progressively compress the intake air flow before delivery to the combustor section 22.

The combustor section 22 includes one or more combustors 54 each having one or more fuel nozzles 56. In certain embodiments, the combustor section 22 may have a single annular combustor 54 extending around a central axis of the gas turbine engine 12. However, in some embodiments, the combustor section 22 may include 2, 3, 4, 5, 6, or more combustors 54 spaced circumferentially about the central axis of the gas turbine engine 12. The fuel nozzles 56 receive a compressed air 58 from the compressor section 20 and fuel 60 from one or more fuel supply systems 62, mix the fuel and air, and ignite the mixture to create hot combustion gases 64, which then exit each combustor 54 and enter the turbine section 24. In certain embodiments, a fuel treatment system 61 may treat the fuel prior to delivery to the fuel nozzles 56. For example, the fuel treatment system 61 may include one or more fuel treatment components 63, such as fuel filters, moisture removal units, acid gas treatment units, or any combination. However, the fuel treatment system 61 may be excluded in certain embodiments.

The turbine section 24 includes one or more turbine stages 66, wherein each turbine stage 66 includes a plurality of turbine blades 68 arranged circumferentially about and coupled to a turbine shaft 70 inside of a turbine casing 72, and a plurality of turbine vanes 74 arranged circumferentially about the turbine shaft 70. The turbine stages 66 may include between 1 and 10 or more turbine stages. Additionally, the turbine stages 66 alternate between sets of the turbine blades 68 and sets of the turbine vanes 74 in the direction of hot combustion gas flow through the turbine section 24. In operation, the hot combustion gases 64 progressively expand and drive rotation of the turbine blades 68 in the turbine stages 66.

The load 26 may include an electrical generator, a machine, or some other driven load. The load 26 may be disposed at the hot end of the gas turbine engine 12 as illustrated in FIG. 1, or the load 26 may be disposed at the cold end of the gas turbine engine 12 (e.g., adjacent the compressor section 20). The exhaust section 28 may include an exhaust duct, exhaust treatment equipment, silencers, or any combination thereof. In some embodiments, the exhaust section 28 may include and/or direct an exhaust flow through a heat exchanger and/or cooling system. As discussed below, the exhaust section 28 may include or be fluidly coupled with the gas treatment system 16.

The control system 14 may include one or more controllers 76, each having a processor 78, memory 80, instructions 82 stored on the memory 80 and executable by the processor 78, and communications circuitry 84 configured to communicate with the gas treatment system 16. The control system 14 is also coupled to various sensors(S), as indicated by element number 86, distributed throughout the combined cycle power plant 10. For example, the sensors 86 may be coupled to and monitor conditions at the air intake section 18, the compressor section 20, the fuel supply systems 62, the combustors 54 of the combustor section 22, the turbine section 24, the load 26, the exhaust section 28, and the gas treatment system 16 (e.g., the gas capture system 100 and the bypass system 102). The control system 14 is configured to receive feedback from the sensors 86 to facilitate adjustments of various operating parameters of the gas turbine engine 12, such as the air intake flow, the fuel supply from the fuel supply system 62 to the combustors 54, operation of exhaust treatment equipment in the exhaust section 28, operation of the gas treatment system 16, or any combination thereof. For example, the control system 14 is configured to operate the bypass system 102 based on feedback from the sensors 86 indicative of conditions impacting operation of the gas treatment system 16, such as a startup condition of the combined cycle power plant 10, a low load condition of the combined cycle power plant 10, a malfunction or other performance issue with the gas treatment system 16, or any combination thereof. As an example, the sensors 86 may obtain feedback indicative of a malfunctioning gas treatment component (e.g., an alert, an alarm, or a controller trip), such as a fan (e.g., a booster fan 145), a pump, a valve, an electric actuator, a steam circulation system, a sorbent-based system of the gas capture system 100, a solvent-based system of the gas capture system, a controller of the gas capture system 100, or any combination thereof. Based on the feedback from the sensors 86, the control system 14 may be configured to operate the bypass system 102 to bypass the exhaust gas flow around the gas treatment system to the exhaust stack. Additional details of the bypass system 102 are discussed in further detail below.

In operation, the gas turbine engine 12 receives air into the inlet duct 30 from the air intake section 18 as indicated by arrows 88, the inlet guide vanes 40 are controlled by the actuators 42 to adjust an angular position of the inlet guide vanes 40 for adjusting air flow into the compressor section 20, and the compressor section 20 is configured to compress the air flow being supplied into the combustor section 22. For example, each stage 44 of the compressor section 20 compresses the air flow with a plurality of the blades 46. The compressed air flow 58 then enters each of the combustors 54, where the fuel nozzles 56 mix the compressed air flow with fuel 60 from the fuel supply system 62. The mixture of fuel and air is then combusted in each combustor 54 to generate the hot combustion gases 64, which flow into the turbine section 24 to drive rotation of the turbine blades 68 in each of the stages 66. The rotation of the turbine blades 68 drives rotation of the turbine shaft 70, which in turn drives rotation of the load 26 and the compressor section 20 via a shaft 90 coupled to the load 26 and a shaft 92 coupled to the compressor shaft 48. The turbine section 24 then discharges an exhaust gas 94 into the exhaust section 28 for final treatment and discharge into the environment.

In the illustrated embodiment, the exhaust section includes a heat recovery steam generator (HRSG) 96 configured to transfer heat from the exhaust gas to water, thereby generating steam to drive a steam turbine system 98. Thus, in the illustrated embodiment, the combined cycle power plant 10 has the gas turbine engine 12 generating power and exhaust gas, the HRSG 96 generating steam from the exhaust gas, and the steam turbine system 98 generating power from the steam. The HRSG 96 may include a plurality of heat exchangers and/or heat exchange components disposed in different sections, such as a high pressure (HP) section, an intermediate pressure (IP) section, and a low pressure (LP) section. The components may include economizers, evaporators, superheaters, or any combination thereof, in each of the HP, IP, and LP sections. Similarly, the steam turbine system 98 may include a plurality of steam turbine sections, such as a high pressure (HP) steam turbine, an intermediate pressure (IP) steam turbine, and a low pressure (LP) steam turbine. In operation, low pressure (LP) steam, intermediate pressure (IP) steam, and high pressure (HP) steam may be supplied from the LP, IP, and HP sections of the HRSG 96 to drive the respective LP, IP, and HP steam turbines of the steam turbine system 98. Additionally, the LP, IP, and/or HP steam from the HRSG 96 may be supplied to the gas treatment system 16 for use in the gas capture system 100.

Downstream from the HRSG 96, the exhaust gas may flow through one or more coolers 99, such as direct and/or indirect coolers (e.g., heat exchangers). The cooler 99, for example, may include a direct contact cooler configured to spray a fluid (e.g., a liquid such as water) directly into the exhaust gas for directly cooling the exhaust gas. The coolers 99 are configured to reduce the temperature of the exhaust gas upstream of the gas treatment system 16.

In the illustrated embodiment, the gas turbine system 10 has the gas treatment system 16 coupled to the exhaust section 28 (e.g., for exhaust gas treatment along an exhaust flow path). However, the gas treatment system 16 also may be coupled to one or more reciprocating piston-cylinder engines, furnaces, boilers, chemical reactors, gasification systems having one or more gasifiers configured to produce a synthesis gas, or other industrial equipment. Each of these gas treatment systems 16 has the features described in further detail below, and the disclosed embodiments are intended to be used in various combinations with one another in all of the foregoing applications. As discussed below, the gas treatment system 16 is described in context of the exhaust flow path for purposes of illustration. The gas treatment system 16 is configured to remove and capture one or more undesirable gases (e.g., acid gases and/or exhaust emissions gases) from the exhaust gas in the gas capture system 100. The gas capture system 100 may include a sorbent-based gas capture system, a solvent-based gas capture system, or any combination thereof.

In operation of the gas capture system 100 (e.g., a sorbent-based gas capture system), a sorbent material is configured to adsorb undesirable gases from the exhaust gas during an adsorption mode, and the sorbent material is configured to desorb the undesirable gases from the exhaust gas during a desorption mode. The adsorption mode is an exothermic process, whereas the desorption mode is an endothermic process. During the desorption mode, a heat source is used to apply heat to the sorbent material, thereby driving the undesirable gases to desorb from the sorbent material. The heat source may include any suitable heat transfer fluid, such as liquids and/or gases. For example, the heat source may include steam and/or heated water. In certain embodiments, the gas capture system 100 may include a vacuum system configured to induce a flow to help withdraw the undesirable gases from the gas capture system 100, such as sorbent materials of a sorbent-based gas capture system.

In operation of the gas capture system 100 (e.g., a solvent-based gas capture system), an absorber is configured to circulate both the exhaust gas and a solvent through a tank in a counter flow arrangement. For example, the absorber may circulate the exhaust gas in a vertically upward direction, while the absorber circulates the solvent in a vertically downward direction. The solvent absorbs the undesirable gases from the exhaust gas. Upon exiting the absorber, the solvent flows through a regeneration unit, which then uses steam to help separate or strip the undesirable gases from the solvent. Thus, the gas capture system 100 may include one or both of the sorbent-based gas capture system and the solvent-based gas capture system to remove and capture the undesirable gases from the exhaust gas.

The undesirable gases include any gases that may be undesirable in the fuel supply and/or exhaust gas. For example, the undesirable gases may include acid gases present in the fuel supply and the exhaust gases. By further example, the undesirable gases in the exhaust gases may include any exhaust emissions gases typically subject to regulation, including but not limited to, carbon oxides (COₓ) such as carbon dioxide (CO₂) and carbon monoxide (CO), nitrogen oxides (NOₓ) such as nitrogen dioxide (NO₂), sulfur oxides (SOₓ) such as sulfur dioxide (SO₂), or any combination thereof. The disclosed embodiments are particularly well suited for gas capture of CO₂ from the exhaust gas. However, the following discussion is intended to cover each of these examples when referring to undesirable gases, even if CO₂ is listed as the only example.

The gas treatment system 16 may include a fluid supply system 104 configured to supply one or more fluids 106 to the gas capture system 100. The fluids 106 (e.g., gases, liquids, and/or vapors) may include a purge fluid, a heated fluid, a cooled fluid, or any combination thereof. For example, the fluids 106 may include a heated water and/or steam 108. The steam 108 may be generated by and/or supplied from the HRSG 96, the steam turbine system 98, and/or one or more additional steam generators such as a boiler 110. The boiler 110 (e.g., a standalone or external boiler) is configured to generate steam 108 from a heat source (e.g., combustion in the boiler 110). The fluid 106 (e.g., heated water and/or steam 108) may be used by the gas capture system 100 to help separate and capture the undesirable gases from the exhaust gas.

In operation, the gas capture system 100 receives and treats the exhaust gas 94 by removing and capturing the undesirable gases, thereby outputting a treated gas 112 (e.g., treated exhaust gas) and a captured gas 114. The treated gas 112 is lean in (or substantially free of) the undesirable gases. The captured gas 114 is rich in or substantially composed of the undesirable gases. The gas capture system 100 uses the fluid 106 (e.g., heated water and/or steam 108) to facilitate the gas capture process, such as by providing heat to facilitate desorption of the undesirable gas from sorbent materials of the sorbent-based gas capture system and/or for separating the undesirable gas from a solvent of the solvent-based gas capture system. The treated gas 112 subsequently flows through an exhaust stack. The captured gas 114 may be routed through downstream equipment 116, such as a dehydration system, a compression system, storage and/or pipeline, or a combination thereof.

During operation, the control system 14 may be configured to operate the bypass system 102 to either (1) enable exhaust gas flow through the gas treatment system 16 (e.g., the gas capture system 100) to remove and capture the undesirable gases or (2) bypass the exhaust gas flow through an exhaust stack without passing the exhaust gas through the gas treatment system 16 (e.g., the gas capture system 100) based on feedback from the sensors 86, user input, a startup condition, a low load condition, a malfunction or performance problem with the gas treatment system 16 (e.g., a fan such as a booster fan), or any combination thereof. The details of the bypass system 102 are discussed in further detail below.

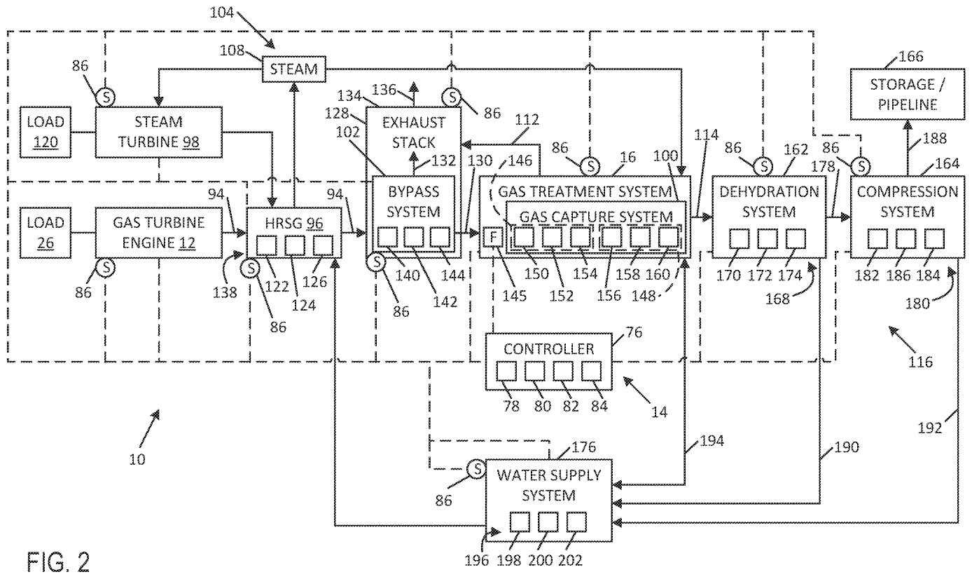

FIG. 2 is a block diagram of an embodiment of the combined cycle power plant 10 of FIG. 1, further illustrating details of the gas capture system 100 of the gas treatment system 16 and the bypass system 102. The combined cycle power plant 10 has the gas turbine engine 12 configured to combust a fuel to generate an exhaust gas 94, which flows through the HRSG 96 to generate the steam 108 for the steam turbine 98 and the gas treatment system 16. The gas treatment system 16, which includes one or more of the gas capture systems 100, is configured to receive and use the steam 108 and/or heated water from the HRSG 96 and/or the steam turbine 98 in one or more conditions (e.g., temperatures, pressures, steam/water content, etc.) to facilitate the removal and capture of undesirable gases (e.g., CO₂) from the exhaust gas. As noted above, although the gas capture system 100 may be well-suited for the removal and capture of CO₂, the undesirable gases may include any one or more of carbon oxides (COₓ) such as carbon dioxide (CO₂) and carbon monoxide (CO), nitrogen oxides (NOₓ) such as nitrogen dioxide (NO₂), sulfur oxides (SOₓ) such as sulfur dioxide (SO₂), or any combination.

In the illustrated embodiment, the gas turbine engine 12 is drivingly coupled to the load 26, such as an electric generator. Similarly, the steam turbine 98 is drivingly coupled to a load 120, such as an electric generator. Collectively, the gas turbine engine 12 and the steam turbine 98 drive the loads 26 and 120 (e.g., electric generators) to generate electricity for the combined cycle power plant 10 and a power grid. The HRSG 96 may include a plurality of sections, such as a low-pressure (LP) section 122, an intermediate-pressure (IP) section 124, and a high-pressure (HP) section 126, which are configured to generate the steam 108 as a low-pressure (LP) steam, an intermediate-pressure (IP) steam, and a high-pressure (HP) steam, respectively. The HRSG 96 transfers heat from the exhaust gas 94 to water and/or steam to generate the LP, IP, and HP steam. In certain embodiments, the steam turbine 98 includes a plurality of steam turbine sections, such as a low-pressure (LP) steam turbine section, an intermediate-pressure (IP) steam turbine section, and a high-pressure (HP) steam turbine section, which are driven by the LP, IP, and HP steam, respectively. Additionally, the gas treatment system 16 may receive and use the steam 108, such as one or more of the LP, IP, and HP steam and/or heated water, from the HRSG 96 and/or the steam turbine 98. After generating the steam 108, the HRSG 96 passes the exhaust gas 94 to an exhaust stack 128.

In the illustrated embodiment, the bypass system 102 may be coupled to the exhaust stack 128, wherein the bypass system 102 may be at least partially or substantially disposed within the exhaust stack 128, an adjacent exhaust duct, the HRSG 96, and/or the gas treatment system 16. The bypass system 102 is configured to control a direction of the exhaust gas 94 along either a gas treatment flow path 130 or a bypass flow path 132. For example, the gas treatment flow path 130 may extend through the gas treatment system 16 and the downstream equipment 116 for treatment of the exhaust gas 94. In contrast, the bypass flow path 132 may extend upwardly through the exhaust stack 128 to a discharge opening 134, wherein the exhaust gas discharges as a discharge flow 136. Thus, the bypass flow path 132 does not pass through the gas treatment system 16, but rather the bypass flow path 132 routes the exhaust gas 94 to bypass the gas treatment system 16.

The bypass system 102 may include a plurality of flow control components 138, such as a first flow control valve or diverter damper 140, a second flow control valve or guillotine damper 142, and a seal gas system 144. The first flow control valve or diverter damper 140 may include a N-port valve or damper, N-way valve or damper, or a combination thereof, wherein N is at least equal to 3 or more. In other words, the first flow control valve or diverter damper 140 may include an inlet (e.g., exhaust gas inlet for the exhaust gas 94), a first outlet (e.g., exhaust gas treatment outlet to the exhaust gas flow path 130), and a second outlet (e.g., bypass outlet to the bypass flow path 132). The first flow control valve or diverter damper 140 may include additional inlets and/or outlets for various applications, samplings, treatments, or uses of the exhaust gas 94. In the following discussion, the first flow control valve or diverter damper 140 is generally referred to as a diverter damper as one possible example, although various configurations are contemplated for the bypass system 102. However, the diverter damper 140 may be generally configured to switch or alternative the flow configuration between the gas treatment flow path 130 (e.g., gas treatment mode) and the bypass flow path 132 (e.g., bypass mode). Although multiple valves could be used for such flow control, the disclosed embodiments use the diverter damper 140 for reduced complexity, improved performance, and improved controllability in the combined cycle power plant 10.

As discussed in further detail below, the controller 76 is coupled to the diverter damper 140 (e.g., a drive or actuator), wherein the controller 76 is configured to move the diverter damper 140 between a first position and a second position, wherein the first position of the diverter damper 140 opens the gas treatment flow path 130 and closes the bypass flow path 132 for the exhaust gas 94 from the gas turbine engine 12. The second position of the diverter damper 140 closes the gas treatment flow path 130 and opens the bypass flow path 132 for the exhaust gas 94 from the gas turbine engine 12. Again, the gas treatment flow path 130 is configured to extend through the gas treatment system 16 having the gas capture system 100, wherein the bypass flow path 132 is configured to bypass the gas treatment system 16 having the gas capture system 100. In other words, the first position of the diverter damper 140 blocks the exhaust flow 94 from discharging through the discharge outlet 134 of the exhaust stack 128, and directs the exhaust flow 94 into the gas treatment system 16 along the gas treatment flow path 130. The second position of the diverter damper 140 blocks the exhaust gas 94 from flowing into the gas treatment system 16 along the gas treatment flow path 130, wherein the diverter damper 140 directs the exhaust gas 94 to flow upwardly through the exhaust stack 128 and through the discharge outlet 134. As discussed below, the diverter damper 140 may include a rotatable door, plate, panel, blade, or valve element, which is coupled to a drive controlled by the controller 76. However, the diverter damper 140 may have other configurations to switch the exhaust gas flow between the gas treatment flow path 130 and the bypass flow path 132.

Additionally and optionally, the second flow control valve or guillotine damper 142 may be included to help isolate the gas treatment system 16 when operating in the bypass mode, wherein the diverter damper 140 closes the gas treatment flow path 130 and opens the bypass flow path 132. The second flow control valve or guillotine damper 142 may include a N-port valve or damper, N-way valve or damper, or a combination thereof, wherein N is at least equal to 2 or more. In the illustrated embodiment, the second flow control valve or guillotine damper 142 may be designed to open or close the gas treatment flow path 132 as a 2-port or 2-way valve or damper. In the following discussion, the second flow control valve or guillotine damper 142 is generally referred to as a guillotine damper as one possible example, although various configurations are contemplated for the bypass system 102.

In operation, the diverter damper 140 may be supplemented by the guillotine damper 142 to provide a more positive seal to block fluid flow between the gas treatment system 16 and the exhaust stack 128, such as to block flow of the undesirable gases (e.g., CO₂) from leaking out of the gas treatment system 16. As discussed below, the guillotine damper 142 may include an axially movable plate, panel, blade, or valve element, which is coupled to a drive controlled by the controller 76. The controller 76 operates the drive to move the guillotine damper 142 linearly upward and downward to open and close the fluid flow into and through the gas treatment system 16 along the gas treatment flow path 130.

Each of the diverter damper 140 and the guillotine damper 142 may include one or more seals configured to provide an airtight seal to block leakage, such as leakage of the exhaust gas 94, the undesirable gases (e.g., CO₂), or any combination thereof. In the illustrated embodiment, the bypass system 102 also has the seal gas system 144 configured to provide a seal gas to the diverter damper 140 and/or the guillotine damper 142 to help provide a buffer gas to block gas leakage. The details of the seal gas system 144 will be discussed in further detail below. Overall, the bypass system 102 is configured to move between the two configurations of either (1) gas treatment mode-enabling exhaust gas flow through the gas treatment system 16 by opening the gas treatment flow path 130 and closing the bypass flow path 132 or (2) bypass mode-bypassing exhaust gas flow through the gas treatment system 16 by closing the gas treatment flow path 130 and opening the bypass flow path 132. The controller 76 is coupled to the bypass system 102 to provide control of the diverter damper 140, the guillotine damper 142, and the seal gas system 144 during operation to provide the correct directional flow and sealing based on various conditions of the combined cycle power plant 10.

For example, the controller 76 may monitor the various sensors 86 to determine if conditions are suitable for gas treatment in the gas treatment 16 or if a bypass is recommended for the exhaust gas 94. In certain embodiments, the bypass system 102 may be operated by the controller 76 to bypass the exhaust gas 94 to flow through the exhaust stack 128 and out through the discharge outlet 134 rather than the gas treatment system 16 based on one or more of: a startup condition of the combined cycle power plant 10, a low part load condition of the combined cycle power plant 10, a malfunction or performance issue in the gas treatment system 16 (e.g., fans, pumps, valves, drives, etc.), a malfunction or problem with the downstream equipment 116, or any other suitable user input or sensor feedback from the sensors 86. For example, the controller 76 may trigger the bypass system 102 to bypass the gas treatment system 16 due an issue (e.g., a trip, failure, or malfunction) with one or more fans that boost the flow of exhaust gas 94 through the gas treatment system 16, wherein the issue may result in insufficient flow of the exhaust gas 94 through the gas treatment system 16 (e.g., gas capture system 100). By further example, the controller 76 may trigger the bypass system 102 to bypass the gas treatment system 16 due to the startup condition, wherein the startup condition has a high level of NOx emissions (e.g., NOx levels above a NOx threshold) that is detrimental to the gas capture process (e.g., carbon capture of CO₂) in the gas capture system 100. By further example, the controller 76 may trigger the bypass system 102 to bypass the gas treatment system 16 due to the low part load condition, wherein the low part load conditions may be due to insufficient bottoming cycle steam to feed the gas capture process (e.g., carbon capture of CO₂) in the gas capture system 100.

The gas treatment system 16 may include one or more of the same or different types of the gas capture system 100. As discussed above, the gas capture system 100 may include one or more fans 145 (e.g., booster fans), a sorbent-based gas capture system 146 and/or a solid-based gas capture system 148. The one or more fans 145 (e.g., electric motor driven fans) are configured to boost a pressure of the exhaust gas 94 flowing through the gas treatment system 16, and particularly through the one or more gas capture systems 100. Each of the gas capture systems 146 and 148 may include a plurality of gas capture components, such as flow control valves, pumps, fans, heaters coolers, actuators or drives, sensors, and/or other controllable elements, which control the gas capture processes. For example, one or more fans (e.g., electric motor driven fans) may be provided upstream, downstream, or within the gas capture systems 100 (e.g., 146 and/or 148) to help force a flow of the exhaust gas 94 through the gas capture system 100. The one or more fans may be in addition to the one or more fans 145 noted above. If one or more of these fans malfunction and/or fail to provide a sufficient pressure of the exhaust gas 94, then the bypass system 102 may be operated by the controller 76 to bypass the gas treatment system 16. The gas capture systems 100 (e.g., 146 and/or 148) also may include one or more components specific to the type of gas capture, e.g., sorbent-based or solvent based gas capture. For example, the sorbent-based gas capture system 146 may include gas capture components 150, 152, and 154. Similarly, the solvent based gas capture system 148 may include a plurality of gas capture components, such as gas capture components 156, 158, and 160.

The sorbent-based gas capture system 146 may have a variety of configurations and operational characteristics using the gas capture components 150, 152, and 154. In certain embodiments, the gas capture component 150 may include sorbent material 150, which is configured to adsorb an undesirable gas (e.g., CO₂) from the exhaust gas 94 during an adsorption mode, and desorb the undesirable gas from the sorbent material 150 during a desorption mode. The gas capture component 152 may include a mode control 152, wherein the mode control 152 is configured to control operational characteristics to either enable flow of the exhaust gas 94 through the sorbent material 150 for adsorption or to disable flow of the exhaust gas 94 through the sorbent material 150 and apply heat to facilitate desorption of the undesirable gas from the sorbent material 150. For example, the sorbent-based gas capture system 146 may supply a source of heat, such as the steam 108 and/or heated water, to the sorbent material 150 during the desorption mode as controlled by the mode control 152. In certain embodiments, the mode control 152 may alternate flows of either the exhaust gas 94 or the steam 108 through the sorbent material 150 in respective adsorption and desorption modes of the sorbent-based gas capture system 146. The sorbent-based gas capture system 146 may use the gas capture component 154 to help extract and/or capture the undesirable gases after desorption from the sorbent material 150. For example, if the sorbent-based gas capture system 146 uses the steam 108 during the desorption mode, then the gas capture component 154 may condense the steam into water and/or generally separate the undesirable gas from the steam 108 to produce the captured gas 114, which is then processed by the downstream equipment 116. For example, the gas capture component 154 may include a vacuum system, a separator, or a combination thereof, wherein the vacuum system is configured to create a vacuum to suck the steam and undesirable gases into the separator, and the separator is configured to separate the undesirable gas (e.g., CO₂) from the steam 108. For example, the separator may include a water gas separator, a cooler and/or condenser, or a combination thereof.

The model control 152 may include a variety of controls to alternate between respective adsorption and desorption modes (or areas of the sorbent material 150) of the sorbent-based gas capture system 146. In some embodiments, the sorbent-based gas capture system 146 may continuously move the sorbent material 150 (e.g., a sorbent material wheel, disc, or rotor) between different flow paths of the exhaust gas 94 and the steam 108, thereby continuously, alternatingly exposing the sorbent material 150 to the exhaust gas 94 for adsorption of the undesirable gas and subsequently exposing the sorbent material 150 to the steam 108 for desorption of the undesirable gas. In some embodiments, the sorbent-based gas capture system 146 may include movable cartridges of the sorbent material 150, which may selectively move back and forth between flow paths of the exhaust gas 94 and steam 108. In certain embodiments, the sorbent-based gas capture system 146 may use the mode control 152 to control valves and other flow control equipment to alternate the flows of the exhaust gas 94 and the steam 108 through one or more passages, each having the sorbent material 150. Accordingly, the sorbent-based gas capture system 146 may have a variety of configurations using the sorbent material 150 to perform the adsorption mode and the desorption mode to capture the undesirable gas from the exhaust gas 94 and generate the captured gas 114.

The solvent-based gas capture 148 also may have a variety of configurations to use solvent (or other fluid) for capturing the undesirable gas from exhaust gas 94 to generate the capture gas 114. In certain embodiments, the gas capture components 156, 158, and 160 may include a cooler, an absorber, and a stripper, respectively. Accordingly, the cooler 156 is configured to cool the exhaust gas 94 prior to entry into the absorber 158. The cooler 156 may be a direct cooler and/or an indirect cooler or heat exchanger. For example, in certain embodiments, the cooler 156 may be a direct contact cooler configured to spray a coolant, such as water, directly into the gas treatment flow path 130 of the exhaust gas 94, thereby directly cooling the exhaust gas 94. However, the cooler 156 may include an indirect cooler or heat exchanger, which uses water or another coolant to transfer heat away from the exhaust gas 94 along the gas treatment flow path 130. The absorber 158 generally includes a container or housing, which provides counter flows of the exhaust gas 94 and a solvent. For example, the absorber 158 may direct the exhaust gas 94 to flow upwardly through the solvent within the absorber 158, while directing the solvent to move downwardly through the absorber 158. The solvent in the absorber 158 is configured to capture or absorb the undesirable gases from the exhaust gas 94, such that the absorber 158 outputs the treated gas 112 and a gas rich solvent (e.g., CO₂-rich solvent) having the undesirable gas (e.g., CO₂). The gas rich solvent then flows through the stripper 160, which is configured to strip the undesirable gas from the gas rich solvent to generate the captured gas 114. For example, in certain embodiments, the stripper 160 may use the steam 108 to help strip the undesirable gas from the gas rich solvent. As appreciated, the solvent-based gas capture system 148 may have a variety of configurations and types of solvents for capturing the undesirable gas from the exhaust gas 94.

Accordingly, the gas treatment system 16 may include one or more different or same types of gas capture systems 100, such as the sorbent-based gas capture system 146 and the solvent based gas capture system 148, arranged in series and/or parallel with one another. In some embodiments, the gas capture system 100 includes only type of the gas capture systems 100, such as the sorbent-based gas capture system 146 or the solvent-based gas capture system 148. The gas treatment system 16 generally outputs the treated gas 112, which may then be directed to the exhaust stack 128 for discharge through the discharge outlet 134 or through a separate exhaust stack. The gas treatment system 16 also discharges the captured gas 114 for further processing by the downstream equipment 116.

In the illustrated embodiment, the downstream equipment 116 includes a dehydration system 162, a compression system 164, and a storage and/or pipeline system 166. The dehydration system 162 is configured to dehydrate or generally remove moisture from the captured gas 114 via one or more dehydration components 168. For example, the dehydration components 168 may include a heat exchanger 170, a separator 172, and a water collector 174. The heat exchanger 170 may be configured to cool the captured gas 114, thereby causing condensation of any moisture within the captured gas 114. The separator 172 may include a water gas separator configured to separate the condensed water from the captured gas 114. In certain embodiments, the separator 172 may include a gravity separator, a centrifugal separator, or any other type of separation unit, or any combination thereof. The water collector 174 may be configured to collect the condensed and separated water and return the water back to a water supply system 176 for subsequent use in the combined cycle power plant 10. In some embodiments, the water collector 174 may include a water drain system, a water tank, a water pump, a water filter, or any combination thereof. As appreciated, the dehydration system 162 may include any one or more types of dehydration components 168. The dehydration system 162, after performing various dehydration processes, outputs the captured gas 114 as a dried captured gas 178 for subsequent compression in the compression system 164.

The compression system 164 may include a plurality of compressor components 180, such as a compressor 182, a compressor 184, and an intercooler or cooling heat exchanger 186. For example, the compressor 182 may be configured to compress the dried captured gas 178 in a first compression stage, the intercooler 186 may be configured to cool the dried captured gas 178 after the first compression stage by the compressor 182, and the compressor 184 may be configured to compress the dried captured gas 178 in a second compression stage after cooling by the intercooler 186. In certain embodiments, the compression system 164 may be a single stage compressor, or the compression components 180 may include 3, 4, 5, or more compressors and associated intercoolers. The compression system 164 then outputs a compressed captured gas 188 to the storage and/or pipeline system 166. Accordingly, the compressed captured gas 188 may be used for a variety of applications either locally in the combined cycle power plant 10 or remotely via the storage and/or pipeline system 166.

The water supply system 176 may receive fresh water, condensed water, or other plant water from various sources throughout the combined cycle power plant 10. For example, the water supply system 176 may receive water from the dehydration system 162 as indicated by arrow 190 (e.g., water conduit), water from the compression system 164 as indicated by arrow 192 (e.g., water conduit), and water from the gas treatment system 16 as indicated by arrow 194 (e.g., water conduit). The water supply system 176 also may supply the water to various equipment throughout the combined cycle power plant 10. For example, the water supply system 176 may supply water to the HRSG 96 for steam generation of the steam 108 (e.g., via water conduit), and water to the gas treatment system 16 for use in various cooling processes within the gas capture system 100. For example, the cooler 156 of the solvent-based gas capture system 148 may use the water from the water supply system 176. Given the various sources and uses of the water, the water supply system 176 may include a plurality of water components 196, such as a water storage 198, a thermal control system 200, and a water treatment system 202. The water storage 198 may include a water storage container, a water storage tower, a water supply conduit, a water reservoir or pond, or any combination thereof. The thermal control system 200 may include a heat exchanger and/or cooling system, which may be configured to control the temperature of the water depending on the desired use throughout the combined cycle power plant 10. For example, the thermal control system 200 may include a cooling tower, an indirect heat exchanger using another thermal fluid to provide cooling, one or more fans, a refrigeration system, a heating system using heat from various sources in the combined cycle power plant 10, or any combination thereof. The water treatment system 202 may include one or more of a filtration system, a chemical treatment system, an impurity removal system, or any combination thereof. Accordingly, the water supply system 176 may supply a thermally controlled and treated water to various locations throughout the combined cycle power plant 10, including but not limited to the HRSG 96 and the gas treatment system 16.

In operation, the controller 76 is configured to control the bypass system 102 to facilitate continued operation of the combined cycle power plant 10 depending on various conditions impacting operation of the gas treatment system 16. For example, if the controller 76 determines that the gas treatment system 16 should not receive a flow of the exhaust gas 94 for processing based on one or more inputs, then the controller 76 may operate the bypass system 102 to block the flow of exhaust gas 94 along the gas treatment flow path 130 and bypass the exhaust gas 94 along the bypass flow path 132 out through the discharge outlet 134 of the exhaust stack 128. The one or more inputs may include, for example, one or more inputs indicative of a malfunction, a performance issue, a startup condition, a low load condition, or any combination thereof, impacting effective operation of the gas treatment system 16 having the gas capture system 100. Conversely, if the controller 76 determines that conditions are suitable for gas treatment in the gas treatment system 16, then the controller 76 may operate the bypass system 102 to enable flow of the exhaust gas 94 along the gas treatment flow path 130 through the gas treatment system 16 and the downstream equipment 116, while generally blocking the flow of exhaust gas 94 out through the discharge outlet 134 of the exhaust stack 128.

In certain embodiments, the controller 76 may operate the bypass system 102 based on various feedback from the sensors 86, user input, alerts and alarms associated with problems in the gas treatment system 16, the dehydration system 162, or the compression system 164, a current state of the combined cycle power plant 10 (e.g., a startup condition, a low load condition, or other condition), or any combination thereof. In this manner, the bypass system 102 enables the combined cycle power plant 10 to continue operating even if the gas treatment system 16 cannot operate for various reasons, and thus the bypass system 102 isolates the gas treatment system 16 while permitting the exhaust gas 94 to exit through the exhaust stack 128. Various aspects of the bypass system 102 are discussed in further detail below.

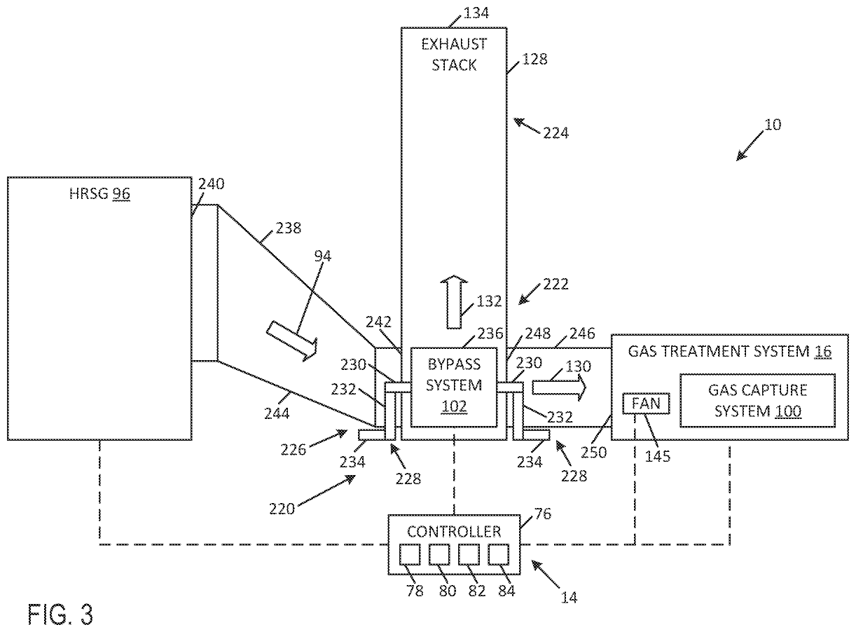

FIG. 3 is a schematic of an embodiment of the combined cycle power plant 10 of FIGS. 1 and 2, further illustrating a lower level bypass configuration 220 of the bypass system 102 coupled to the exhaust stack 128. In the illustrated embodiment, the bypass system 102 is coupled to a lower stack portion 222 of the exhaust stack 128, such as a ground level or base stack portion of the exhaust stack 128. The exhaust stack 128 also has an upper stack portion 224 extending vertically upward above the bypass system 102 in the lower stack portion 222. Accordingly, the bypass flow path 132 extends through the upper stack portion 224 of the exhaust stack 128 to the discharge outlet 134. The bypass system 102 may be supported by a support 226 having a plurality of legs 228, wherein each of the legs 228 includes one or more lateral supports 230, one or more vertical supports 232, and one or more feet 234. As illustrated, the legs 228 extend from opposite sides of the bypass system 102, wherein the lateral supports 230 extend outwardly from the bypass system 102, the vertical supports 232 extend downwardly from the lateral supports 230 to the respective feet 234, and the feet 234 may be disposed on a ground level or fixed in place. The bypass system 102 also may include a framework or housing 236 coupled to the support 226, such that the support 226 and the framework 236 hold the bypass system 102 in the desired position in the lower stack portion 222 of the exhaust stack 128. Additional details of the bypass system 102 are discussed in further detail below.

As further illustrated in FIG. 3, the HRSG 96 is coupled to the lower stack portion 222 of the exhaust stack 128 via a transition duct 238, which may include an expansion joint 240 coupled to the HRSG 96, an expansion joint 242 coupled to the lower stack portion 222 of the exhaust stack 128, and a downward transition portion 244 extending between and coupled to the expansion joints 240 and 242. The transition duct 238 is inclined in a downward direction toward the bypass system 102 disposed in the lower stack portion 222. However, the transition duct 238 may be oriented in a horizontal direction or an upward incline in certain embodiments. The exhaust stack 128 is also coupled to the gas treatment system 16 via a duct 246. The duct 246 may be oriented in a horizontal direction, an upward incline, or a downward incline between the exhaust stack 128 and the gas treatment system 16. In the illustrated embodiment, the duct 246 is generally oriented in a horizontal direction between an expansion joint 248 coupled to the lower stack portion 222 of the exhaust stack 128 and an expansion joint 250 coupled to the gas treatment system 16. The expansion joints 240, 242, 248, and 250 may include a variety of seals, movable connections, and flexible joints, thereby allowing movement between the parts while maintaining a seal. For example, the expansion joints 240, 242, 248, and 250 may include hula seals, bellows, metal seals, axially moveable joints, springs, or any combination thereof.

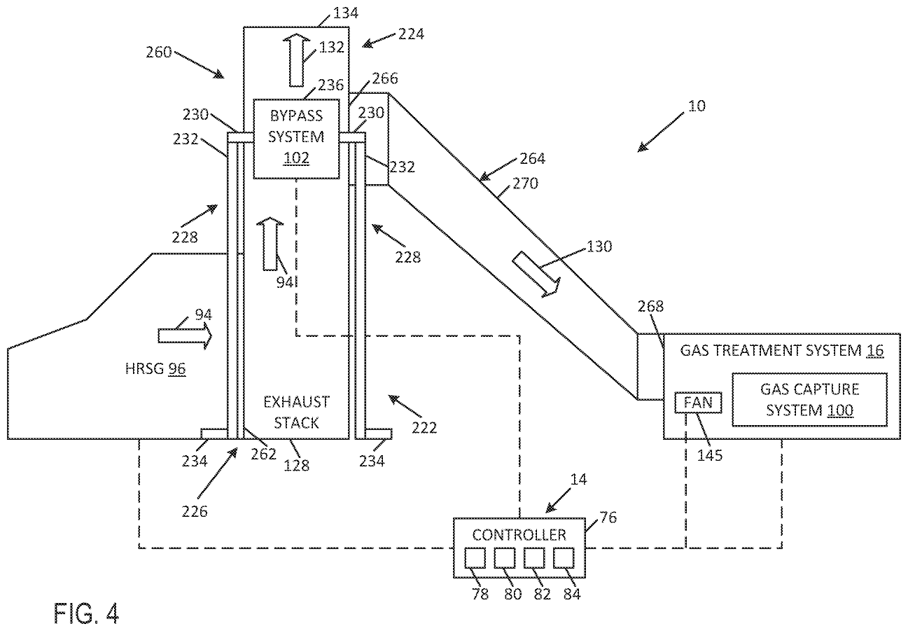

FIG. 4 is a schematic of an embodiment of the combined cycle power plant 10 of FIGS. 1-3, further illustrating an elevated level bypass configuration 260 of the bypass system 102 coupled to the exhaust stack 128. The bypass system 236 is supported in a similar manner as discussed above with reference to FIG. 3. However, the bypass system 102 of the elevated level bypass configuration 260 is supported by the support 226 in the upper stack portion 224 of the exhaust stack 128. Accordingly, the lower stack portion 222 of the exhaust stack 128 extends vertically upward from the HRSG 96 to the bypass system 102 in the upper stack portion 224, such that the exhaust gas 94 flows vertically upward before reaching the bypass system 102. The support 226 has similar elements as discussed in detail above with reference to FIG. 3. However, the legs 228 are extended to the upper stack portion 224, such that the vertical supports 232 are generally longer than those shown in FIG. 3. Otherwise, the support 226 has a similar construction of the legs 228, including the lateral supports 230, the vertical supports 232, and the feet 234, to support the framework or housing 236 of the bypass system 102.

The HRSG 96 is coupled to the lower stack portion 222 via an expansion joint 262, which may be similar to the expansion joints 240, 242, 248, and 250 as discussed above. The upper stack portion 224 of the exhaust stack 128 is coupled to a transition duct 264, which extends to the gas treatment system 16. The transition duct 264 includes an expansion joint 266 coupled to the upper stack portion 224 of the exhaust stack 128 adjacent the bypass system 102, and an expansion joint 268 coupled to the gas treatment system 16. Again, the expansion joints 266 and 268 may have a similar construction to the expansion joints 240, 242, 248, and 250, as discussed above. In the illustrated embodiment, the transition duct 264 includes a downward transition portion 270 extending from the upper stack portion 224 to the gas treatment system 16. Accordingly, the downward transition portion 270 may include a downward incline from the elevated level bypass configuration 260 of the bypass system 236 to the gas treatment system 16. However, in certain embodiments, the downward transition portion 270 may include a vertical downward transition portion, a curved downward transition portion, a horizontal transition portion, or any combination thereof. In the elevated level bypass configuration 260, the bypass system 102 is disposed in the upper stack portion 224, which may be at a position of at least equal to or greater than 50, 60, 70, 80, or 90 percent of an overall height of the exhaust stack 128. The incline of the downward transition portion 270 may include an angle relative to the ground of at least equal to or greater than 10, 20, 30, 40, 50, 60, or greater degrees. Additional details of the bypass system 102 are discussed in further detail below.

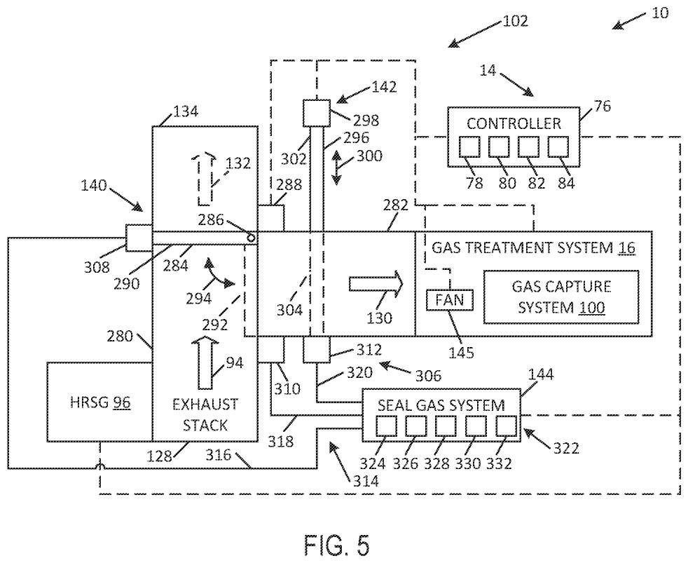

FIG. 5 is a schematic of an embodiment of the combined cycle power plant 10 of FIGS. 1-4, further illustrating details of the bypass system 102 coupled to the exhaust stack 128 and the gas treatment system 16. In the illustrated embodiment, the bypass system 102 is at least partially or substantially coupled to a duct 280 of the exhaust stack 128 and a duct 282 extending to or part of the gas treatment system 16. For example, the duct 280 may be a vertical duct of the exhaust stack 128, while the duct 282 may be a horizontal duct, a downwardly inclined duct, an upwardly incline duct, or any combination thereof, between the duct 280 and the gas treatment system 16. The diverter damper 140, the guillotine damper 142, and the seal gas system 144 may be coupled to one or both of the ducts 280 and 282 to provide flow control of the exhaust gas 94 into one or both of the gas treatment flow path 130 and the bypass flow path 132.

In the illustrated embodiment, the diverter damper 140 has a door 284 coupled to a pivot joint 286 and a drive 288, wherein the drive 288 is configured to rotate the door 284 about the pivot joint 286 between a first position 290 and a second position 292. The first position 290 of the door 284 blocks the duct 280 and opens the duct 282, thereby directing the exhaust gas 94 through the exhaust stack 128 and the duct 282 into and through the gas treatment system 16 along the gas treatment flow path 130. In this first position 290, the door 282 blocks the exhaust gas 94 from continuing to flow upward through the exhaust stack 128 along the bypass flow path 132 and out through the discharge outlet 134. In the second position 292, the door 284 opens the exhaust stack 128 along the duct 280 and out through the discharge outlet 134, while blocking the duct 282. Accordingly, the second position 292 of the door 284 enables flow of the exhaust gas 94 upwardly through the exhaust stack 128, through the duct 280 along the bypass flow path 132, and out through the discharge outlet 134. However, the second position 292 of the door 284 blocks the duct 282, such that the exhaust gas 94 cannot enter and flow through the duct 282 along the gas treatment flow path 130 into and through the gas treatment system 16.

The diverter damper 140 may include various constructions of the door 284, the pivot joint 286, and the drive 288. The door 284 may include a rotatable panel, plate, blade, slab, valve element, damper element, or a combination thereof. The door 284 may be constructed of metal, insulating materials, or any combination thereof. The pivot joint 286 may include a hinge, a shaft, pins, or any other suitable rotatable joint, such that the door 284 can rotate between the first and second positions 290 and 292 as indicated by arrow 294. The drive 288 may include an electric drive, a fluid drive, a gear assembly or transmission, or any combination thereof. For example, the drive 288 (e.g., electric drive) may include an electric motor, an electric actuator, electronic controls, or any combination thereof. The drive 288 (e.g., fluid drive) may include a gas or pneumatic drive, a liquid or hydraulic drive, a gear assembly, a transmission, fluid controls, or any combination thereof. For example, the drive 288 may include a fluid-driven, piston-cylinder assembly, which is driven by a fluid source to move a piston within a cylinder to provide motion to drive the door 282. In certain embodiments, the drive 288 may include a gear assembly or transmission configured to convert linear motion into rotational motion (e.g., a linear to rotational motion conversion assembly), thereby providing the rotational movement of the door 284 between the first and second positions 290 and 292.

The guillotine damper 142 may include a gate 296 coupled to a drive 298, wherein the drive 298 is configured to move the gate 296 along a linear path of movement as indicated by arrow 300 between an open position 302 disposed outside of the duct 282 and a closed position 304 extending across an interior of the duct 282. In the open position 302, the gate 296 is retracted outside of the duct 282, such that the gate 296 does not impede the flow of the exhaust gas 94 along the gas treatment flow path 130. In the closed position 304, the gate 296 extends internally within and across the duct 282, thereby blocking flow of the exhaust gas 94 into and through the duct 282 along the gas treatment flow path 130 to the gas treatment system 16. The drive 298 may include any and all of the features described above with reference to the drive 288. The drive 298 may include an electric drive, a fluid drive, a gear assembly or transmission, or any combination thereof. For example, the drive 298 (e.g., electric drive) may include an electric motor, an electric actuator, electronic controls, or any combination thereof. The drive 298 (e.g., fluid drive) may include a gas or pneumatic drive, a liquid or hydraulic drive, a gear assembly, a transmission, fluid controls, or any combination thereof. For example, the drive 298 may include a fluid-driven, piston-cylinder assembly, which is driven by a fluid source to move a piston within a cylinder to provide motion to drive the gate 296. The drive 298 is configured to provide a linear force to move the gate 296 along the linear path of travel as indicated by arrow 300. The guillotine damper 142 may be operated to supplement the diverter damper 140 when sealing off the duct 282 in a bypass configuration of the bypass system 102 (e.g., bypass mode).

The seal gas system 144 may be coupled to the bypass system 102 at the diverter damper 140 and the guillotine damper 142 to facilitate sealing in the various positions of the diverter damper 140 and the guillotine damper 142. For example, the seal gas supply 144 may include a plurality of seal gas injectors 306, such as a seal gas injector 308 coupled to the duct 280 adjacent the door 284 in the first position 290, a seal gas injector 310 coupled to the duct 282 adjacent the door 284 in the second position 292, and a seal gas injector 312 coupled to the duct 282 adjacent the gate 296 in the closed position 304 of the guillotine damper 142. The seal gas injectors 306, including the seal gas injectors 308, 310, and 312, may be coupled to the seal gas system 144 via a gas supply circuit 314. The gas supply circuit 314 may include gas supply conduits 316, 318, and 320 coupled to the respective seal gas injectors 308, 310, and 312. Each of the seal gas injectors 306 is configured to inject a seal gas from the seal gas system 144 into a sealing area to facilitate sealing and block leakage of the exhaust gas 94 and/or undesirable gases (e.g., CO₂) from the ducts 280 and 282. For example, the seal gas supplied through the seal gas injector 308 is configured to help seal and block leakage of the door 284 at the first position 290, the seal gas injector 310 uses the seal gas to help seal the door 284 at the second position 292, and the seal gas injector 312 uses the seal gas to help seal the gate 296 in the closed position 304 in the duct 282.

The seal gas system 144 may include a plurality of seal components 322, such as a seal gas source 324, one or more filters 326, one or more flow inducers 328, a distribution manifold 330, and one or more valves 332. As discussed in further detail below, the seal gas source 324 may include one or more storage tanks or containers of a seal gas, such as air, an inert gas (e.g., nitrogen), or another suitable gas compatible with the flows through the exhaust stack 128 and the gas treatment system 16. The filter 326 may include a cartridge filter, one or more screen filters, a particle separator, a water separator, a particulate media separator or filter, or any combination thereof. The flow inducers 328 may include one or more compressors, fans (e.g., electric motor driven fans), blowers (e.g., electric motor driven blowers), or any combination thereof. For example, the one or more compressors may include a rotary compressor or a reciprocating compressor, wherein the compressors may include one or more stages of compression, an intercooler, or any combination thereof. In certain embodiments, the flow inducers 328 may include any flow control configured to induce a flow of the seal gas source 324. The distribution manifold 330 may include an inlet and a plurality of outlets configured to distribute the seal gas through the gas supply circuit 314.

The controller 76 is communicatively coupled to the gas treatment system 16 and the bypass system 102 to facilitate control of the position of the diverter damper 140, the position of the guillotine damper 142, and the sealing provided by the seal gas system 144. For example, the controller 76 may determine when to bypass the exhaust gas flow along the bypass flow path 132 or direct the exhaust gas 94 along the gas treatment flow path 130 depending on one or more inputs. The one or more inputs may be indicative of a malfunction, a performance issue, a startup condition, a low load condition, or any combination thereof, impacting effective operation of the gas treatment system having the gas capture system. The one or more inputs may be received as sensor feedback from the sensors 86, user input via a computer or user interface, conditions of the combined cycle power plant 10 (e.g., startup or low load condition), malfunctions or other issues in the gas treatment system 16, or any combination thereof. Depending on the input, the controller 76 may be configured to move the door 284 to the first position 290 and move the gate 296 to the open position 302 by controlling the drives 288 and 298, respectively, to operate in a gas treatment mode. In the gas treatment mode, the exhaust gas 94 can flow through the gas treatment flow path 130 for treatment in the gas treatment system 16, while the diverter damper 140 blocks flow along the bypass flow path 132. The controller 76 also may control movement of the door 284 to the second position 292 and movement of the gate 296 to the closed position 304, thereby blocking the duct 282 and opening the duct 280 to operate in a bypass mode. In the bypass mode, the exhaust gas 94 is blocked from passing through the gas treatment flow path 130, and generally bypasses the gas treatment system 16 via flow upwardly through the duct 280 along the bypass flow path 130 out through the discharge outlet 134. In certain embodiments, the guillotine damper 142 may be included or excluded depending on the needs for sealing the duct 282. The guillotine damper 142 is configured to provide redundant sealing and closure of the duct 282 in the bypass mode, thereby helping to isolate the gas treatment system 16 from the exhaust stack 128 when operating the combined cycle power plant 10 in the bypass mode using the bypass flow path 132.

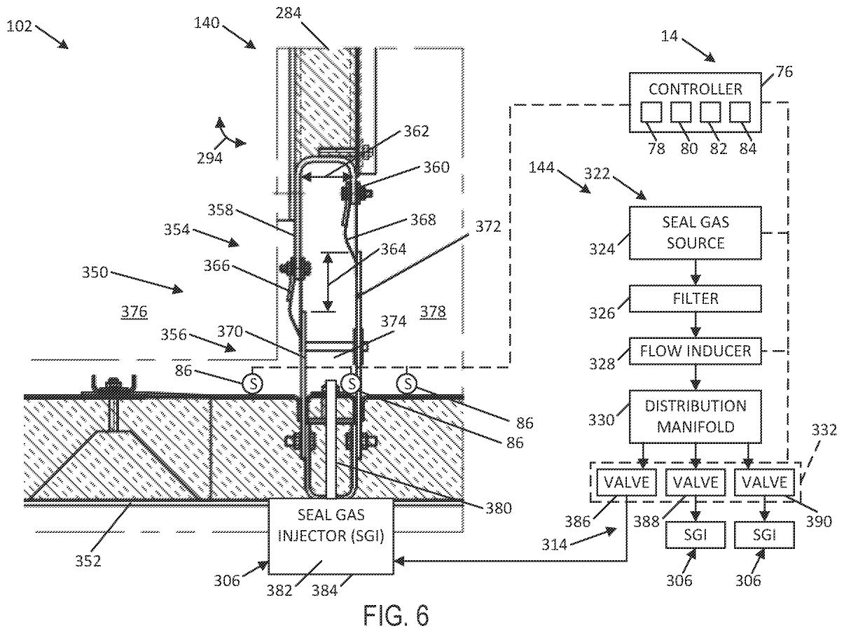

FIG. 6 is a schematic of an embodiment of the seal gas system 144 of the combined cycle power plant 10 of FIGS. 1-5, further illustrating details of the seal components 322, the seal gas injectors 306, and a seal system 350 using the seal gas. In the illustrated embodiment, the seal system 350 is disposed between a wall 352 and the door 284 of the diverter damper 140, which may correspond to the first position 290 or the second position 292 of the door 284 as discussed above with reference to FIG. 5. However, the seal system 350 also may be used with the gate 296 of the guillotine damper 142. In the illustrated embodiment, the seal system 350 includes a staggered seal assembly 354 coupled to the door 284 and a staggered seal assembly 356 coupled to the wall 352. The staggered seal assembly 354 may include seal plates 358 and 360, wherein the seal plates 358 and 360 are spaced apart from one another by a distance 362, and the seal plates 358 and 360 are staggered relative to one another by a distance 364. The seal plate 358 further includes a seal 366 and the seal plate 360 includes a seal 368. The seals 366 and 368 are similarly offset and staggered by the distances 362 and 364.

Separate from the door 284 having the staggered seal assembly 354, the wall 352 has the staggered seal assembly 356. As illustrated, the staggered seal assembly 356 includes seal plates 370 and 372, which are generally offset by the distance 362 and staggered by the distance 364 in a similar manner as the staggered seal assembly 354. In certain embodiments, the distances 362 and 364 may be the substantially the same (e.g., within 5, 10, 15, or 20 percent of one another) for the staggered seal assemblies 354 and 356. However, in certain embodiments, the distances 362 and/or 366 may vary between the staggered seal assembly 354 and 356. As discussed above, the door 284 is configured to rotate about pivot joint 286 between the first and second positions 290 and 292, along a rotating path of travel as indicated by arrow 294. When the door 284 generally closes at a particular position, the staggered seal assemblies 354 and 356 of the seal system 350 engage with one another to seal the door 284 relative to the wall 252. For example, the seal plates 358 and 360 having the respective seals 366 and 368 of the staggered seal assembly 354 generally open and close against the seal plates 370 and 372 of the staggered seal assembly 356. When the staggered seal assemblies 354 and 356 are closed against one another, a seal chamber 374 forms between the staggered seal assemblies 354 and 356. For example, the seal chamber 374 may be surrounded by the seal plates 358, 360, 370, and 372 and the seals 366 and 368. The seal chamber and the engagement of the staggered seal assemblies 354 and 356 may extend around one or more sides of the door 284, such as 1, 2, 3, or 4 sides of the door 284.

The seal gas system 144 is configured to provide a seal gas into the seal chamber 374, thereby providing a positive pressure within the seal chamber 374 to help reduce leakage between opposite sides 376 and 378 of the door 284. The seal chamber 374 is configured to receive a seal gas from the seal gas system 144 via an injection nozzle 380 coupled to the seal gas injection 306. The injection nozzle 380 may include one or more openings, passages, or conduits through the wall 352 into the seal chamber 374. The seal gas injector 306 may include a buffer chamber 382 disposed within an enclosure 384, such that the buffer chamber 382 may help to regulate and distribute the seal gas flowing through the seal gas injector 306 into the seal chamber 374. The seal gas injector 306 is coupled to the seal gas system 144 via the gas supply circuit 314.

As discussed above, the seal gas system 144 includes a plurality of seal components 322, such as the seal gas source 324, the filter 326, the flow inducer 328 (e.g., fan, blower, compressor, etc.), the distribution manifold 330, and valves 332. For example, the valves 332 may include valves 386, 388, and 390 coupled to respective seal gas injectors 306 at various locations of the combined cycle power plant 10. For example, the valves 386, 388, and 390 may be coupled to the respective conduits 316, 318, and 320 leading to the seal gas injectors 308, 310, and 312 as discussed above with reference to FIG. 5. Other aspects of the seal gas system 144 are as described above.

The controller 76 is configured to control the seal components 322 of the seal gas system 144 based on feedback from one or more sensors 86. For example, one of the sensors 86 may be disposed within the seal chamber 374, thereby providing feedback on conditions (e.g., pressure, temperature, gas composition, etc.) within the seal chamber 374. The controller 76 also may be configured to receive feedback from sensors 86 disposed on the opposite sides 376 and 378 of the door 284, thereby providing sensor feedback of conditions (e.g., pressure, temperature, gas composition, etc.) on the opposite sides 376 and 378 of the door 284. Accordingly, the controller 76 may receive the sensor feedback for conditions in the seal chamber 374, the side 376, and the side 378, and make comparisons of the sensor feedback to control the injection of seal gas into the seal chamber 374. For example, if the pressure of the seal gas within the seal chamber 374 is less than the gas pressure on one or both of the sides 376 and 378, then the controllers 76 may control the seal gas system 144 to apply greater flow and/or pressure of the seal gas through the seal gas injector 306 into the seal chamber 374 until the seal gas pressure within the seal chamber 374 exceeds the corresponding pressure on the side 376 and/or the side 378. The controller 76 also may control other aspects of the seal gas system 144, such as which seal gas injectors 306 need a seal gas pressure depending on the position of the door 284 and the gate 296. The seal gas system 144 may help to seal the diverter damper 140, such that the bypass system 102 may be able to operate without any additional dampers, valves or flow controls (e.g., the guillotine damper 142) for the exhaust gas 94.

Technical effects of the disclosed embodiments include a system and method for bypassing the gas treatment system 16, including one or more gas capture systems 100, depending on various conditions in the combined cycle power plant 10. For example, the disclosed embodiments may operate the bypass system 102 to open or close a diverter damper 140 and a guillotine damper 142 to either route the exhaust gas 94 along the gas treatment flow path 130 through the gas treatment system 16 or through the bypass flow path 132 that generally bypasses the gas treatment system 16. The bypass system 102 also may be coupled to or include the seal gas system 144, which is configured to supply a seal gas to help seal and block leakage flows in the diverter damper 140 and the guillotine damper 142. The disclosed embodiments also may be configured to operate the bypass system 102 depending on sensor feedback from sensors 86, a startup condition or low load condition of the combined cycle power plant 10, malfunctioning or problematic parts within the gas treatment system 16, user input, or any combination thereof. Accordingly, if the gas treatment system 16 cannot be used for some reason, then the bypass system 102 operates to bypass the gas treatment system 16 to route the exhaust gas 94 through the discharge outlet 134 of the exhaust stack 128 to enable continued use and operation of the combined cycle power plant 10.

The subject matter described in detail above may be defined by one or more clauses, as set forth below.

In certain embodiments, a system includes a bypass system having a first valve, a first drive coupled to the first valve, and a controller coupled to the first drive. The controller is configured to operate the first drive to move the first valve between a first position and a second position. The first position of the first valve opens a gas treatment flow path and closes a bypass flow path for an exhaust gas flow from a gas turbine engine. The second position of the first valve closes the gas treatment flow path and opens the bypass flow path for the exhaust gas flow from the gas turbine engine. The gas treatment flow path is configured to extend through a gas treatment system having a gas capture system. The bypass flow path is configured to bypass the gas treatment system having the gas capture system.

The system of the preceding clause, wherein the bypass system includes a diverter damper having the first valve coupled to the first drive, and the first valve includes a diverter blade configured to rotate about a pivot joint.

The system of any preceding clause, wherein the bypass system includes a second drive coupled to a second valve, wherein the controller is configured to operate the second drive to move the second valve between an open position and a closed position, wherein the open position of the second valve opens the gas treatment flow path, wherein the closed position of the second valve closes the gas treatment flow path.

The system of any preceding clause, wherein the bypass system includes a guillotine damper having the second valve coupled to the second drive, and the second valve includes a guillotine blade configured to move along an axial path between the open position and the closed position.

The system of any preceding clause, wherein the controller is configured to operate the first drive to move the first valve from the first position to the second position in response to one or more inputs indicative of a malfunction, a performance issue, a startup condition, a low load condition, or any combination thereof, impacting effective operation of the gas treatment system having the gas capture system.

The system of any preceding clause, including a seal gas system coupled to the bypass system, wherein the seal gas system is configured to supply a seal gas to help block leakage at the first valve.

The system of any preceding clause, wherein the seal gas system includes a seal gas injector and one or more sensors to monitor pressure at the first valve.

The system of any preceding clause, wherein the gas capture system is configured to remove and capture at least one undesirable gas from the exhaust gas flow, wherein the at least one undesirable gas includes one or more of carbon oxides (COX), nitrogen oxides (NOX), or sulfur oxides (SOX).

The system of any preceding clause, wherein the gas capture system is configured to remove and capture carbon dioxide (CO2) from the exhaust gas flow.

The system of any preceding clause, wherein the gas capture system includes at least one of a sorbent-based gas capture system, a solvent-based gas capture system, or a combination thereof.

The system of any preceding clause, including an exhaust stack, wherein the bypass system is coupled to the exhaust stack.

The system of any preceding clause, wherein the bypass system is coupled to a lower stack portion of the exhaust stack.

The system of any preceding clause, wherein the bypass system is coupled to an upper stack portion of the exhaust stack.

The system of any preceding clause, including the gas treatment system having the gas capture system coupled to the exhaust stack along the gas treatment flow path.

The system of any preceding clause, including a heat recovery steam generator (HRSG) configured to provide the exhaust gas flow into the exhaust stack, the gas turbine engine configured to provide the exhaust gas flow into the HRSG, or a combination thereof.

In certain embodiments, a system includes a controller coupled to a bypass system having a first drive coupled to a first valve, wherein the controller is configured to operate the first drive to move the first valve between a first position and a second position. The first position of the first valve opens a gas treatment flow path and closes a bypass flow path for an exhaust gas flow from a gas turbine engine. The second position of the first valve closes the gas treatment flow path and opens the bypass flow path for the exhaust gas flow from the gas turbine engine. The gas treatment flow path is configured to extend through a gas treatment system having a gas capture system. The bypass flow path is configured to bypass the gas treatment system having the gas capture system.

The system of the preceding clause, wherein the controller is configured to operate the first drive to move the first valve from the first position to the second position in response to one or more inputs indicative of a malfunction, a performance issue, a startup condition, a low load condition, or any combination thereof, impacting effective operation of the gas treatment system having the gas capture system.

The system of any preceding clause, wherein the gas capture system is configured to remove and capture carbon dioxide (CO2) from the exhaust gas flow.

In certain embodiments, a method includes controlling a first drive to move a first valve of a bypass system to a first position to open a gas treatment flow path and close a bypass flow path for an exhaust gas flow from a gas turbine engine, wherein the gas treatment flow path is configured to extend through a gas treatment system having a gas capture system. The method also includes controlling the first drive to move the first valve of the bypass system to a second position to close the gas treatment flow path and open the bypass flow path for the exhaust gas flow from the gas turbine engine, wherein the bypass flow path is configured to bypass the gas treatment system having the gas capture system.

The method of the preceding clause, including controlling the first drive to move the first valve from the first position to the second position in response to one or more inputs indicative of a malfunction, a performance issue, a startup condition, a low load condition, or any combination thereof, impacting effective operation of the gas treatment system having the gas capture system, wherein the gas capture system is configured to remove and capture carbon dioxide (CO2) from the exhaust gas flow.

This written description uses examples to describe the present embodiments, including the best mode, and also to enable any person skilled in the art to practice the presently disclosed embodiments, including making and using any devices or systems and performing any incorporated methods. The patentable scope of the presently disclosed embodiments is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a bypass system, comprising:
a first valve;
a first drive coupled to the first valve; and
a controller coupled to the first drive, wherein the controller is configured to operate the first drive to move the first valve between a first position and a second position, wherein the first position of the first valve opens a gas treatment flow path and closes a bypass flow path for an exhaust gas flow from a gas turbine engine, wherein the second position of the first valve closes the gas treatment flow path and opens the bypass flow path for the exhaust gas flow from the gas turbine engine, wherein the gas treatment flow path is configured to extend through a gas treatment system having a gas capture system, wherein the bypass flow path is configured to bypass the gas treatment system having the gas capture system.

2. The system of claim 1, wherein the bypass system comprises a diverter damper having the first valve coupled to the first drive, and the first valve comprises a diverter blade configured to rotate about a pivot joint.

3. The system of claim 1, wherein the bypass system comprises a second drive coupled to a second valve, wherein the controller is configured to operate the second drive to move the second valve between an open position and a closed position, wherein the open position of the second valve opens the gas treatment flow path, wherein the closed position of the second valve closes the gas treatment flow path.

4. The system of claim 3, wherein the bypass system comprises a guillotine damper having the second valve coupled to the second drive, and the second valve comprises a guillotine blade configured to move along an axial path between the open position and the closed position.

5. The system of claim 1, wherein the controller is configured to operate the first drive to move the first valve from the first position to the second position in response to one or more inputs indicative of a malfunction, a performance issue, a startup condition, a low load condition, or any combination thereof, impacting effective operation of the gas treatment system having the gas capture system.

6. The system of claim 1, comprising a seal gas system coupled to the bypass system, wherein the seal gas system is configured to supply a seal gas to help block leakage at the first valve.

7. The system of claim 6, wherein the seal gas system comprises a seal gas injector and one or more sensors to monitor pressure at the first valve.

8. The system of claim 1, wherein the gas capture system is configured to remove and capture at least one undesirable gas from the exhaust gas flow, wherein the at least one undesirable gas comprises one or more of carbon oxides (COₓ), nitrogen oxides (NOₓ), or sulfur oxides (SOₓ).

9. The system of claim 1, wherein the gas capture system is configured to remove and capture carbon dioxide (CO₂) from the exhaust gas flow.

10. The system of claim 1, wherein the gas capture system comprises at least one of a sorbent-based gas capture system, a solvent-based gas capture system, or a combination thereof.

11. The system of claim 1, comprising an exhaust stack, wherein the bypass system is coupled to the exhaust stack.

12. The system of claim 11, wherein the bypass system is coupled to a lower stack portion of the exhaust stack.

13. The system of claim 11, wherein the bypass system is coupled to an upper stack portion of the exhaust stack.

14. The system of claim 11, comprising the gas treatment system having the gas capture system coupled to the exhaust stack along the gas treatment flow path.

15. The system of claim 11, comprising a heat recovery steam generator (HRSG) configured to provide the exhaust gas flow into the exhaust stack, the gas turbine engine configured to provide the exhaust gas flow into the HRSG, or a combination thereof.

16. A system, comprising:
a controller coupled to a bypass system having a first drive coupled to a first valve, wherein the controller is configured to operate the first drive to move the first valve between a first position and a second position, wherein the first position of the first valve opens a gas treatment flow path and closes a bypass flow path for an exhaust gas flow from a gas turbine engine, wherein the second position of the first valve closes the gas treatment flow path and opens the bypass flow path for the exhaust gas flow from the gas turbine engine, wherein the gas treatment flow path is configured to extend through a gas treatment system having a gas capture system, wherein the bypass flow path is configured to bypass the gas treatment system having the gas capture system.

17. The system of claim 16, wherein the controller is configured to operate the first drive to move the first valve from the first position to the second position in response to one or more inputs indicative of a malfunction, a performance issue, a startup condition, a low load condition, or any combination thereof, impacting effective operation of the gas treatment system having the gas capture system.

18. The system of claim 16, wherein the gas capture system is configured to remove and capture carbon dioxide (CO₂) from the exhaust gas flow.

19. A method, comprising:
controlling a first drive to move a first valve of a bypass system to a first position to open a gas treatment flow path and close a bypass flow path for an exhaust gas flow from a gas turbine engine, wherein the gas treatment flow path is configured to extend through a gas treatment system having a gas capture system; and
controlling the first drive to move the first valve of the bypass system to a second position to close the gas treatment flow path and open the bypass flow path for the exhaust gas flow from the gas turbine engine, wherein the bypass flow path is configured to bypass the gas treatment system having the gas capture system.

20. The method of claim 19, comprising controlling the first drive to move the first valve from the first position to the second position in response to one or more inputs indicative of a malfunction, a performance issue, a startup condition, a low load condition, or any combination thereof, impacting effective operation of the gas treatment system having the gas capture system, wherein the gas capture system is configured to remove and capture carbon dioxide (CO₂) from the exhaust gas flow.
